(19) United States
(12) Patent Application Publication
(10) Pub. No.: US 2009/0217150 A1
(43) Pub. Date: Aug. 27, 2009

(54) SYSTEMS AND METHODS FOR COLLABORATIVE ANNOTATION

(76) Inventor: Yi Lin, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/184,944

(22) Filed: Aug. 1, 2008

Related U.S. Application Data
(60) Provisional application No. 61/031,955, filed on Feb. 27, 2008.

(51) Int. Cl. G06F 3/00

(52) U.S. Cl. 715/232

(57) ABSTRACT

A method (and corresponding system and computer program product) that enables users to collaboratively annotate images and selectively review user annotations online is described. Images and annotation tools are made available in web pages. Users can initiate the collaborative annotation process by annotating the images using the annotation tools embedded in the web pages. The images, the related user annotations, and the annotation tools are made available in web pages. Users can retrieve the web pages and make further annotations and/or selectively review the related annotations using the annotation tools. The subsequent annotations are recorded and added to the web pages for further review and additional annotations.

### BACKGROUND OF THE INVENTION

1. Field of Disclosure

The disclosure generally relates to the field of electronic communication, in particular to online collaboration.

2. Description of the Related Art

Many users access and analyze images (e.g., X-ray images, stock charts) using computers. These users often prefer to collaborate with others in the analysis to share knowledge and points of view. However, currently there is no adequate solution on the market for users to collaboratively analyze images and conveniently review the collaborative analysis.

One common conventional approach for users to conduct image analysis is through specialized software such as financial charting software and medical image analysis software. Users can use the software to customize images and draw markups (e.g., trend lines). However, these software do not provide users with capability to collaboratively analyze images with others.

One common conventional approach to share content is through exchange of emails (or newsgroup posts) among participants. Each participant shares his contributions with others through emails addressed to the others. The other participants can offer feedbacks and additional analysis in responding emails. This approach tends to generate large volumes of emails, making it hard for users to track the collaborative work. In addition, email applications generally do not provide image analysis functionalities. Therefore, if users want to conduct collaborative image analysis, they must also have access to separate analysis software.

Hence, there is lacking, inter alia, a system and method for users to collaboratively analyze images and conveniently review the analysis.

### SUMMARY OF THE INVENTION

The present invention overcomes limitations of the prior art by providing an online collaborative annotation platform. This allows users to collaboratively annotate images such as medical images and financial charts and review user annotations in a simple and intuitive manner.

In one aspect, the collaborative annotation platform provides images for user annotation along with annotation tools in web pages. Users can initiate the collaborative annotation process by annotating the images using the annotation tools. The images, the related user annotations, and the annotation tools are made available in web pages. Users can retrieve the web pages and make further annotations and/or selectively review the existing annotations using the annotation tools. The subsequent annotations are recorded and added to the web pages for further review and additional annotations.

Other aspects of the invention include software, systems and components of systems for implementing the techniques described above. Yet additional aspects include methods and applications for all of the foregoing.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings (figures). A brief description of the drawings is as follows:

Figure (FIG.) 1 is a diagram illustrating a computing environment for providing an online collaborative annotation platform.

FIG. 2 is a diagram illustrating a structure of a computer.

FIG. 3 is a diagram illustrating an architecture of an annotation server shown in FIG. 1.

FIG. 4 is a flow diagram illustrating an operation of the annotation server shown in FIG. 3.

FIGS. 5A-5F are a series of user interface screenshots illustrating a process for multiple users to collaboratively annotate a financial chart through a online collaborative annotation platform provided by the annotation server shown in FIGS. 3 and 4.

### DETAILED DESCRIPTION OF THE PREFERRED EMBODIMENTS

### Overview

The disclosed embodiments describe examples of a method (and corresponding system and computer program product) for enabling users to collaboratively annotate content, share annotated content, and review user annotations.

As described herein, the content being annotated utilizing the present invention can be financial charts for securities (e.g., stock charts), medical images (e.g., X-ray images, MRI images), or any other type of content (textual, audio, video, picture, game, Flash, to name only a few), generated by users or otherwise. Content annotation may be for purposes such as chart analysis, money management, portfolio analysis, and interpretation and diagnosis of injuries and abnormalities.

An annotation entry includes one or more content markups (e.g., graphical markups on stock price charts such as trend lines) accompanied with one or more descriptive comments (e.g., textual comments, audio/video clips).

For purposes of illustration, the invention is described in terms of enabling ordinary Internet users to collaboratively annotate financial charts and conveniently review user annotations (collectively called collaborative charting), even though the disclosed embodiments apply to all other types of content annotation as defined above.

The methods for providing collaborative charting can be implemented through a server-based computing environment, an example of which is described in detail below with regard to FIG. 1. One skilled in the art would readily understand that the present disclosure is not restricted to this architecture, and can be implemented in other computing environments such as peer-to-peer computing environment.

### Computing Environment

FIG. 1 is a diagram illustrating a computing environment 100 for providing an online collaborative annotation platform for ordinary Internet users to conduct collaborative charting according to one embodiment of the present invention. The computing environment 100 includes an annotation server 110 and multiple client devices 120 communicatively connected through a network 130. As illustrated, the computing environment employs client-server architecture, the annotation server 110 functions as the server system and the client devices 120 function as the client systems.

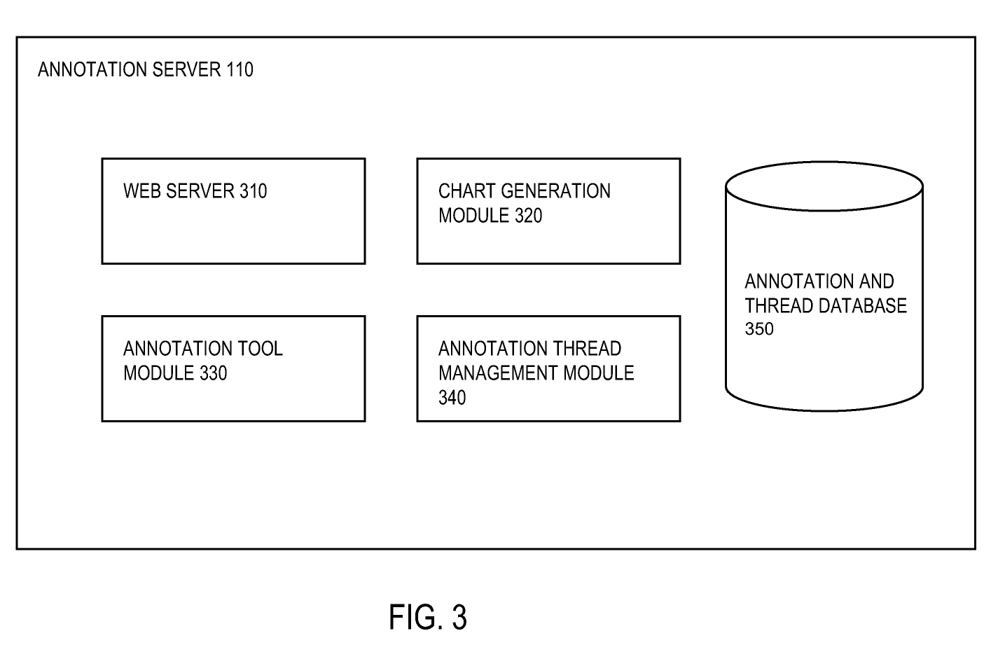

The annotation server 110 is a hardware and/or software device that enables users to collaboratively annotate content by interacting with the client devices 120. The annotation server 110 also enables users to conveniently share and review the annotated content. In one embodiment, the annotation server 110 includes a web server that hosts or generates web pages including financial charts and embedded annotation tools enabling users to make, share, and review annotation entries for the financial charts. A detailed example architecture of the annotation server 110 is described in detail below with respect to FIG. 3.

A client device 120 is a hardware and/or software device for users to interact with the annotation server 110 through the network 130. Examples of a client device 120 include a personal computer (laptop or desktop), a mobile phone, a personal digital assistant (PDA), and other mobile computing devices. A client device 120 can have one or more operating systems such as Microsoft Windows, LINUX, and/or a variant of UNIX. In one embodiment, a client device 120 includes a browser application (e.g., Palm Blazer™, Opera mobile browser, Microsoft Internet Explorer™, Mozilla Firefox™, or Apple Safari™) for users to access the web pages retrieved from the annotation server 110 and utilize the embedded annotation tools to conduct collaborative charting.

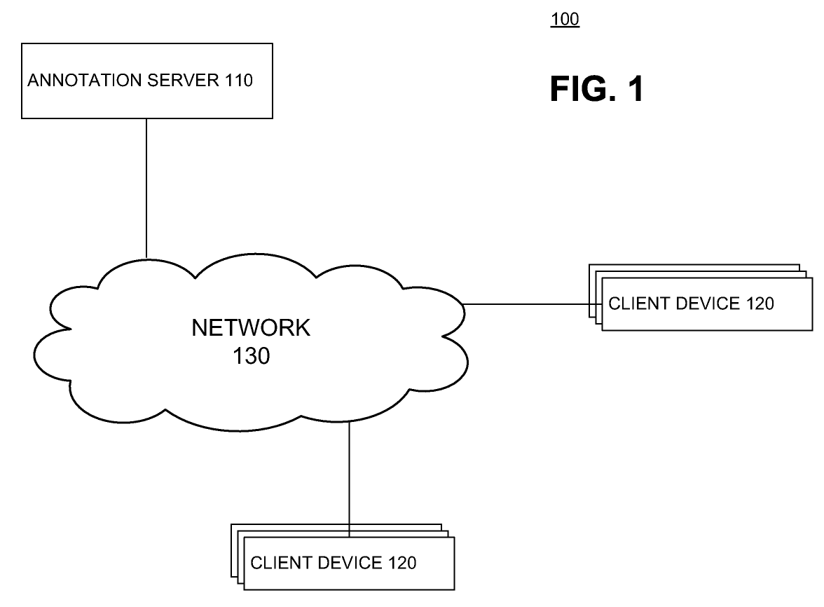

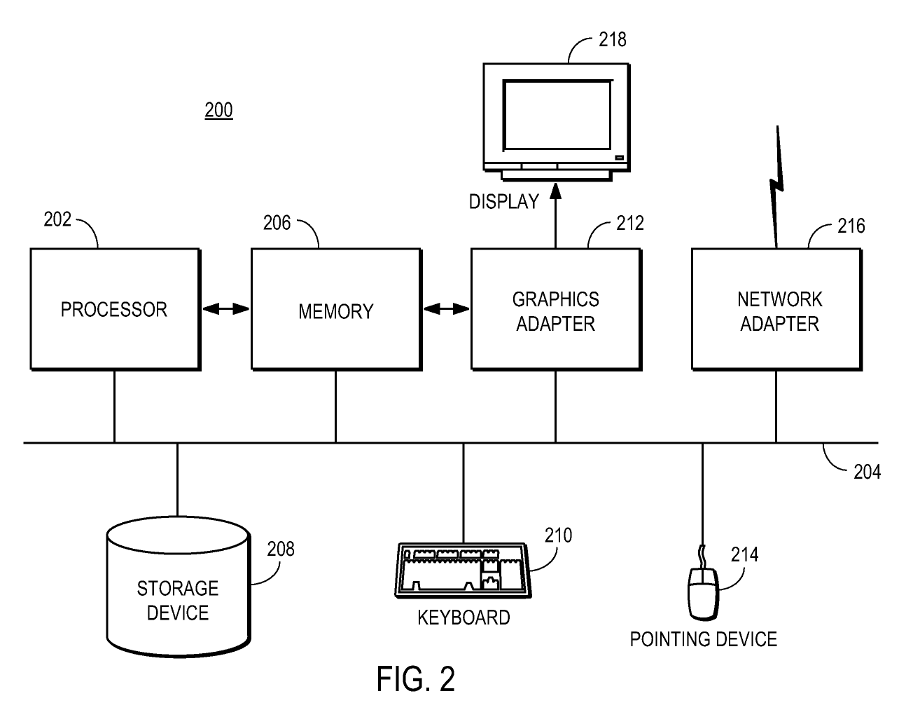

The annotation server 110 and the client devices 120 may be stored and operated on a computer 200 as illustrated in FIG. 2 according to one embodiment. Referring to FIG. 2, the computer 200 includes at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

Referring back to FIG. 1, the network 130 is configured to connect the annotation server 110 and the client devices 120. The network 130 may be a wired or wireless network. Examples of the network 130 include the Internet, an intranet, a WiFi network, a WiMAX network, a mobile telephone network, or a combination thereof.

### System Architecture for Annotation Server

FIG. 3 is a high-level block diagram illustrating modules within the annotation server 110 in FIG. 1 according to one embodiment. Those of skill in the art will recognize that other embodiments can have different and/or additional modules than those shown in FIG. 3. Likewise, the functionalities can be distributed among the modules in a manner different than described herein. Further, some of the functions can be provided by entities other than the annotation server 110. As illustrated, the annotation server 110 includes a web server 310, a chart generation module 320, an annotation tool module 330, an annotation thread management module 340, and an annotation and thread database 350.

The web server 310 is a front end of the annotation server 110 and functions as a communication gateway into and out of the annotation server 110. In one example, the web server 310 provides an online collaborative annotation platform website with web pages including financial charts and annotation tools. It is noted that the web server 310 is not limited to an Internet web server, but rather can be any communication gateway that appropriately interfaces the network 130, such as a cell phone system communication front end.

The chart generation module 320 is designed to generate financial charts (or any annotatable content) for user annotation. The chart generation module 320 may generate financial charts based on data from external data sources (e.g., stock data providers, stock exchanges), internal data (e.g., locally stored historical market data), or user provided data. In one variation, rather than (or in addition to) generating financial charts, the chart generation module 320 may also retrieve existing financial charts internally (e.g., previously generated charts) and/or externally (e.g., charts provided by users) and provide them for user annotation. In one embodiment, the charts are represented using markup languages such as HyperText Markup Language (HTML) and transmitted to the client devices 120 for display in web pages.

The annotation tool module 330 is designed to provide users with annotation tools (a.k.a. client component, annotation panel) for annotating financial charts and interacting with existing annotation entries. The annotation tools provide users with controls to create graphical markups (a.k.a. visual annotation) and textual comments (a.k.a. textual annotation). Users can group the markups and comments into annotation entries. The annotation tools also record user annotations and transmit them back to the annotation server 110 for storage. In one embodiment, the annotation tools record graphical markups in abstract form (e.g., as XML or JSON strings) and send the recorded markups together with textual comments to the annotation server 110 for storage. Depending on their configuration (e.g., type and version of operating system and/or browser application), the annotation tool module 330 may provide different annotation tools to different client devices 120.

Examples of the controls in the annotation tools include drawing controls for creating various graphical markups such as lines, triangles, format controls such as color and line weight, and text controls such as a dialog box for textual comments. The annotation tools also provide users with controls to selectively review others' annotation entries. For example, the annotation tools can provide users with the following options: showing all annotation entries, hiding all annotation entries, and showing only the first annotation entry. Alternatively (or in addition), the annotation tools can present a checkbox for each annotation entry available for display. Users can choose to review certain annotation entries (or their graphical markups) by selecting their checkboxes. In addition, the annotation tools may also include association controls for grouping markups and comments into annotation entries, and thread controls for storing user annotations in a preexisting annotation thread or starting a new thread.

For purpose of illustration, the annotation tools are described as being implemented in a web application embedded in web pages, even though one of ordinary skill in the art will readily recognize that the annotation tools can be implemented in other manners, such as a web applet, a plug-in of web browsers, and a stand-alone software application running on the client device 120.

The annotation thread management module 340 is designed to manage annotation threads. In one embodiment, annotation entries made for a financial chart are organized into different annotation threads, similar to user posts in different discussion threads in Internet forums. An annotation thread for a financial chart may contain zero, one or more annotation entries, and has a unique Uniform Resource Locator (URL). Users can access the financial chart and user annotations of an annotation thread by visiting its URL (the thread URL). An annotation thread can be bifurcated (e.g., upon user request) into multiple parallel annotation threads. The bifurcated annotation threads inherit all annotation entries from the original annotation thread at the time of bifurcation.

The annotation and thread database 350 is designed to store all information related to user annotations and annotation threads. The annotation and thread database 350 may be a relational database or any other type of database that stores the data, such as a flat file.

### Operation of Annotation Server

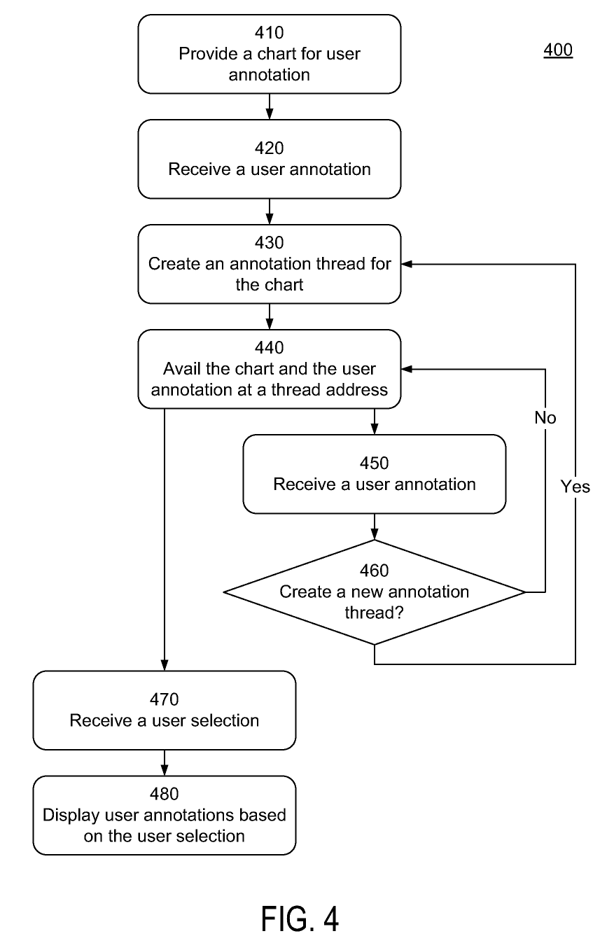

FIG. 4 is a flowchart illustrating a method 400 performed collectively by the annotation server 110 and the client devices 120 for users to collaboratively annotate an image and selectively review annotation entries of the image according to one embodiment. One or more portions of the method 400 may be implemented in embodiments of hardware and/or software or combinations thereof. For example, the method 400 may be embodied through instructions for performing the actions described herein and such instrumentations can be stored within a tangible computer readable medium such as the memory 206, and are executable by a processor such as the processor 202. Furthermore, those of skill in the art will recognize that other embodiments can perform the steps of the method 400 in different order. Moreover, other embodiments can include different and/or additional steps than the ones described here. The annotation server 110 can perform multiple instances of the method 400 concurrently and/or perform steps of the method 400 in parallel.

Initially, the annotation server 110 provides 410 an image for user annotation. As described above with reference to the web server 310 and the chart generation module 320 in FIG. 3, the image can be generated internally or retrieved from external sources (e.g., uploaded by a user), and provided 410 in a web page for user annotation.

A user retrieves the web page including the image and the annotation tools, and creates one or more annotation entries. As noted above, an annotation entry may include multiple components. For example, the user may draw a trend line on the financial chart and make a comment on the trend line. The graphical markup (the trend line) and the textual comment are components of the same annotation entry. The annotation tools record the annotation entry (the first annotation entry) and transmit it to the annotation server 110 for storage (e.g., in the annotation and thread database 350). In one implementation, the annotation recordation is real time and automatic. Alternatively or in conjunction, the user can trigger the annotation recordation (e.g., by selecting a control for saving current annotation entry).

After the annotation server 110 receives 420 the first annotation entry, it creates 430 an annotation thread (the original thread) for collaborative user annotation of the image. The annotation server 110 stores the received annotation entry and avails 440 the image together with the annotation entry in a web page at the thread URL (the thread web page). The thread address can become available at the online collaborative annotation platform website hosted by the web server 310 or be transmitted to others at the user's preference (e.g., via email).

Other users can access the first annotation entry by visiting the thread web page. When a second user (a participant of the collaborative annotation) requests the thread web page, the annotation server 110 generates the thread web page including the image, the first annotation entry, and the embedded annotation tools, and sends to the client device 120 of the second user for display. The annotation tools (or the web browser) on the client device 120 displays the textual comments and playbacks the graphical markups together with the image. The second user can then make further annotations for the annotated image. The annotation server 110 receives 450 the annotation entry from the second user (the second annotation entry) and stores it.

In one embodiment, the second user has an option of creating 460 a new annotation thread for his annotation. If he indicates that he does not intend to create 460 a new thread, the annotation server 110 avails 440 the first and second annotation entries in the thread web page associated with the original thread. Alternatively, if the second user indicates that he intends to create 460 a separate annotation thread (e.g., by selecting a corresponding control), the annotation server 110 creates 430 a new annotation thread and avails 440 the first and second annotations in a thread web page associated with the new thread. In this case the second annotation entry would not affect the original thread.

Annotation entries added to a thread become available immediately for subsequent accesses. For example, the annotation tools actively check the annotation server 110 for annotation updates of the underlying thread. If a new annotation entry becomes available, the annotation tools retrieve and display the update in real time.

A user can selectively view annotation entries. After retrieving a thread web page, the user can choose to display only those annotation entries he deems interesting, and to hide the rest. The user may also turn on/off all user annotations or only those associated with a particular user. After receiving 470 the user selection, the annotation tools display 480 (or turn on) only those selected annotation entries and hide (or minimize, turn off) the rest. As noted above, an annotation entry may include one or more graphical markups and accompanying text comments. If an annotation entry is turned on, all of its components will be displayed and otherwise hidden or minimized. In another embodiment, only graphical markups are affected by user selection, and not the textual comments.

### EXAMPLE USER EXPERIENCE

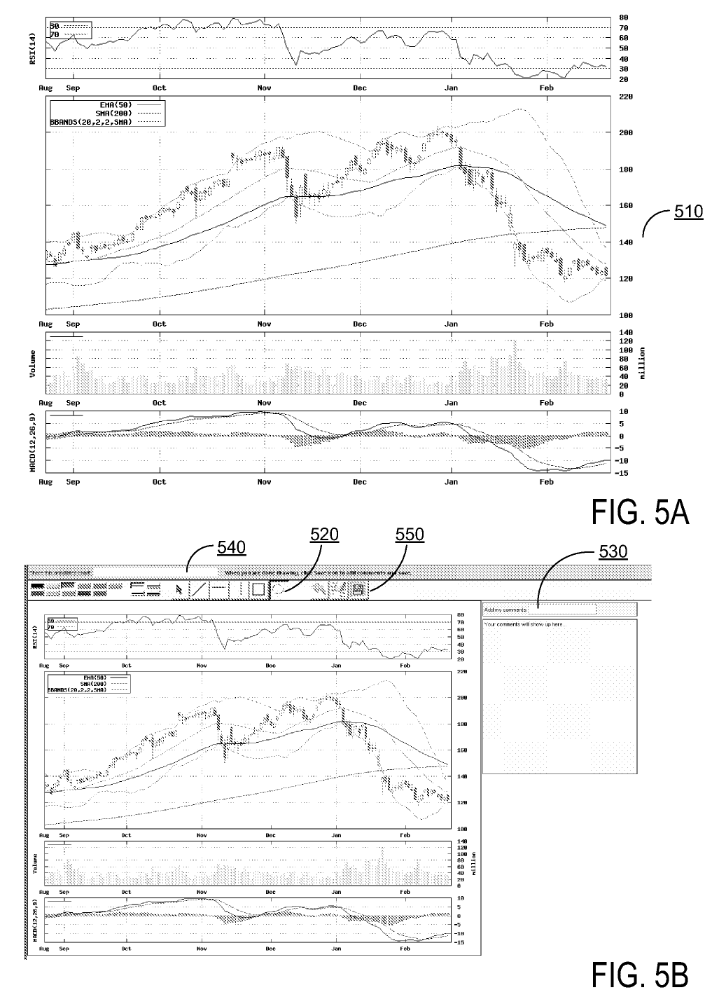

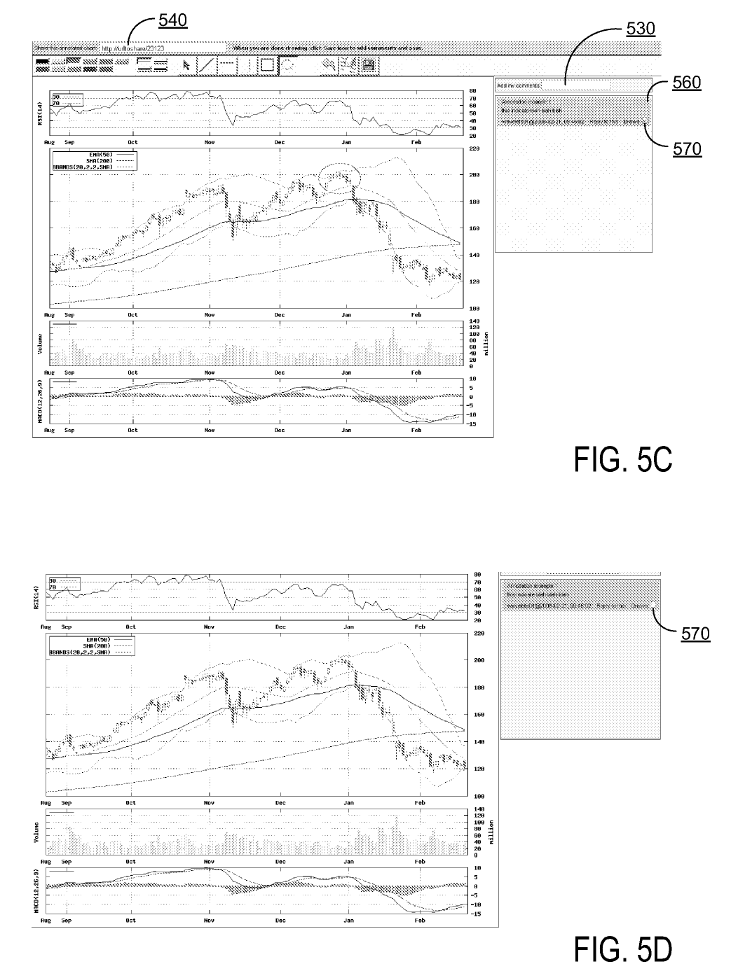

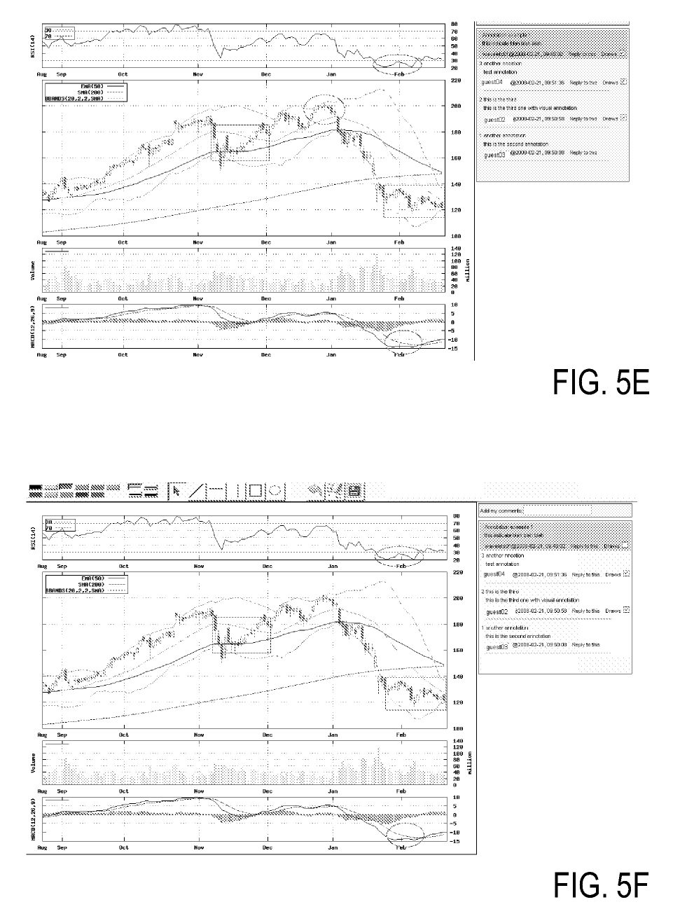

FIGS. 5A-5F are a series of user interface screenshots illustrating a process for multiple users to collaboratively annotate a financial chart through the online collaborative annotation platform provided by the annotation server 110 shown in FIG. 1.

FIG. 5A shows the original financial chart 510 available for collaboratively annotation. As shown, the financial chart contains a time-sequence price chart for a security, a corresponding volume chart, and charts for two technical indicators: Relative Strength Index (RSI) and Moving Average Convergence/Divergence (MACD).

The annotation server 110 provides 410 the financial chart 510 for user annotation in a web page together with embedded annotation tools. FIG. 5B shows a screenshot of the web page as displayed on the client device 120. As illustrated, the web page includes the financial chart 510 and the annotation tools, which include a group of controls 520 for creating graphical markups, and controls 530 to make and display textual comments. In addition, the annotation tools include a control 540 for users to create an annotation thread, and a control 550 to store an annotation entry with a current annotation thread.

The user can utilize the annotation tools to annotate and thus initiate the collaborative annotation process. As shown in FIG. 5C, the user draws a red ellipse around a section of the price chart (e.g., using a pointer such as a mouse or a touchpad). It is noted that the user can control attributes of the markup by selecting the preferred controls in the annotation tools. In this case, the user selected (as indicated by controls appearing as pressed down buttons) red color, light line weight, and eclipse shape for the graphical markup. The user also made the following textual comments using the control 530 “this indicate blah blah blah.” The textual comment is displayed along with time (2008-02-21, 09:46:02) and identity information (wavelets01) about the user in a control 560. The control 560 also displays a checkbox 570 and a label Draws next to the textual comments for users to select to display or hide the corresponding graphical markup(s), in this case the red eclipse. If a user chooses to uncheck the checkbox 570, as illustrated in FIG. 5D, the red eclipse is hidden from the financial chart. This enables users to conveniently review multiple graphical markups because a user can selectively display a subset of the markups to avoid being distracted by others.

The annotation tools track and record the annotation entries the user made and transmits them to the annotation server 110 upon user request (e.g., the user selecting the control 540 or the control 550). The annotation server 110 receives the annotation entry, creates 430 an annotation thread for the financial chart, and avails the financial chart and the annotation entry at a thread web page. In the present example, the user explicitly requires a new thread being created for the user comment by providing a URL http://urltoshare/23123 in the control 540. It is noted that the URL can be automatically generated by the annotation server 110.

Users can access the financial chart along with existing annotation entries by visiting the thread web page at the thread URL (http://urltoshare/23123). Users can also make additional annotations using the embedded annotation tools. FIG. 5E is a partial screenshot showing the financial chart with additional markups and textual comments. As illustrated, three different users (guest02, guest03, guest04) have subsequently visited the thread URL and added their annotations. Specifically, guest03 noted “this is the second annotation;” guest02 noted “this is the third one with visual annotation;” and guest04 noted “test annotation.” The three users also added the following graphical markups: purple eclipses in the RSI chart and the MACD chart, a purple rectangular and a red rectangular in the price chart. It is noted that there is no checkbox next to guest03's comment because he did not make any graphical markups.

Users can choose to turn on or off any of the graphical markups on the financial chart. As illustrated in FIG. 5F, a user unchecked the checkbox for the first annotation entry. As a result, the corresponding red eclipse is no longer displayed on the price diagram.

### Alternative Embodiments

As noted above, even though the disclosed invention is described in terms of graphical markups and textual comments for financial charts, one of ordinary skill in the art will readily recognize that the invention can be applied to any type of collaborative work (annotation or otherwise) and review, such as collaborative development of electronic content that may not involve securities, charts, or annotations.

For example, the disclosed invention can be applied in the field of interpretation and diagnosis of injuries and abnormalities. A physician uncertain about his patient's condition may upload the patient's medical image (e.g., an X-ray image) onto an collaborative annotation platform for other specialized physicians to review and contribute in making the right diagnosis. The physician may also draw markups on the X-ray image and provide accompanying comments. A radiologist, residing in the same hospital or around the globe, can retrieve the thread web page and make additional comments and markups. Other doctors or medical personals may review the existing annotations and share their points of view by making additional annotations. The physician can then selectively review each and every annotation entry provided by the contributors, and make a diagnosis based on the group wisdom.

In one variation, a user (e.g., the user initiating an annotation thread) can limit others' rights in making annotation or in bifurcating an existing annotation thread. For example, the user can allow some users to freely annotate and bifurcate the thread, subject some other users' such activity to his approval, and forbidding the rest users rights to such activity. The user can also restrict access by requesting authentication for privacy concerns.

The disclosed embodiments advantageously provide a convenient way for ordinary Internet users to collaboratively work together and selectively review the collaborative work.

Some portions of above description describe the embodiments in terms of algorithmic processes or operations, for example, the processes and operations as described with FIG. 4. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for enabling Internet users to conveniently collaboratively work together and review the collaborative work. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method for collaborative annotation, comprising:
providing an image, one or more related annotation entries, and annotation tools in a web page at a Uniform Resource Locator (URL);
selectively displaying the one or more annotation entries on the web page based on a user selection;
receiving an annotation entry for the image through the annotation tools; and
availing the annotation entry together with the one or more related annotation entries in the web page.

2. The method of claim 1, wherein providing the image, the one or more related annotation entries, and the annotation tools in the web page at the URL comprises:
providing the image along with the annotation tools for user annotation;
receiving a first annotation entry for the image from a first user through the annotation tools;
availing the first annotation entry and the image in the web page;
receiving a second annotation entry for the image from a second user; and
availing the second annotation entry together with the first annotation entry in the web page, the first annotation entry and the second annotation entry being among the one or more related annotation entries.

3. The method of claim 1, wherein the user selection comprises a subset of the one or more related annotation entries, and wherein selectively displaying comprises displaying only the subset of annotation entries and not the rest annotation entries.

4. The method of claim 1, wherein the image is a financial chart and an annotation entry includes a graphical markup and a textual comment.

5. The method of claim 4, wherein selectively displaying comprises displaying graphical markups of the one or more annotation entries on the web page based on the user selection.

6. The method of claim 1, further comprising creating multiple annotation threads for the image, annotation entries made in one annotation thread not affecting other annotation threads.

7. The method of claim 6, wherein two or more of the multiple annotation threads are bifurcated from one annotation thread, and share annotation entries with the annotation thread existing at the time of bifurcation.

8. A system for collaborative annotation, comprising:
means for providing an image, one or more related annotation entries, and annotation tools in a web page at a Uniform Resource Locator (URL);
means for selectively displaying the one or more annotation entries on the web page based on a user selection;
means for receiving an annotation entry for the image through the annotation tools; and
means for availing the annotation entry together with the one or more related annotation entries in the web page.

9. The system of claim 8, wherein the means for providing the image, the one or more related annotation entries, and the annotation tools in the web page at the URL comprises:
means for providing the image along with the annotation tools for user annotation;
means for receiving a first annotation entry for the image from a first user through the annotation tools;
means for availing the first annotation entry and the image in the web page;
means for receiving a second annotation entry for the image from a second user; and
means for availing the second annotation entry together with the first annotation entry in the web page, the first annotation entry and the second annotation entry being among the one or more related annotation entries.

10. The system of claim 8, wherein the user selection comprises a subset of the one or more related annotation entries, and wherein the means for selectively displaying comprises means for displaying only the subset of annotation entries and not the rest annotation entries.

11. The system of claim 8, wherein the image is a financial chart and an annotation entry includes a graphical markup and a textual comment.

12. The system of claim 11, wherein the means for selectively displaying comprises means for displaying graphical markups of the one or more annotation entries on the web page based on the user selection.

13. The system of claim 8, further comprising means for creating multiple annotation threads for the image, annotation entries made in one annotation thread not affecting other annotation threads.

14. The system of claim 13, wherein two or more of the multiple annotation threads are bifurcated from one annotation thread, and share annotation entries with the annotation thread existing at the time of bifurcation.

15. A computer program product for collaborative annotation, the computer program product comprising a computer-readable medium containing computer program code for performing a method comprising:
providing an image, one or more related annotation entries, and annotation tools in a web page at a Uniform Resource Locator (URL);
selectively displaying the one or more annotation entries on the web page based on a user selection;
receiving an annotation entry for the image through the annotation tools; and
availing the annotation entry together with the one or more related annotation entries in the web page.

16. The computer program product of claim 15, wherein providing the image, the one or more related annotation entries, and the annotation tools in the web page at the URL comprises:
providing the image along with the annotation tools for user annotation;
receiving a first annotation entry for the image from a first user through the annotation tools;
availing the first annotation entry and the image in the web page;
receiving a second annotation entry for the image from a second user; and
availing the second annotation entry together with the first annotation entry in the web page, the first annotation entry and the second annotation entry being among the one or more related annotation entries.

17. The computer program product of claim 15, wherein the user selection comprises a subset of the one or more related annotation entries, and wherein selectively displaying comprises displaying only the subset of annotation entries and not the rest annotation entries.

18. The computer program product of claim 15, wherein the image is a financial chart and an annotation entry includes a graphical markup and a textual comment.

19. The computer program product of claim 18, wherein selectively displaying comprises displaying graphical markups of the one or more annotation entries on the web page based on the user selection.

20. The computer program product of claim 15, further comprising creating multiple annotation threads for the image, annotation entries made in one annotation thread not affecting other annotation threads.

21. The computer program product of claim 20, wherein two or more of the multiple annotation threads are bifurcated from one annotation thread, and share annotation entries with the annotation thread existing at the time of bifurcation.
